(19) United States
(12) Patent Application Publication
(10) Pub. No.: US 2003/0174796 A1
(43) Pub. Date: Sep. 18, 2003

(54) Data synchronizing apparatus, synchronization information transmitting apparatus, data synchronizing method, synchronization information transmitting method, and program

(76) Inventor: Yoshimasa Isozaki, Shizuoka-ken (JP)

Correspondence Address: HARNESS, DICKEY & PIERCE, P.L.C., P.O. BOX 828, BLOOMFIELD HILLS, MI, 48303, US

(21) Appl. No.: 10/389,439

(22) Filed: Mar. 14, 2003

(30) Foreign Application Priority Data
Mar. 15, 2002 (JP) 2002-072564

(51) Int. Cl. H04L 7/00

(52) U.S. Cl. 375/354

(57) ABSTRACT

There is provided a data synchronizing apparatus which enables reproduction of a plurality of kinds of received data that are received in accurate synchronism, The data synchronizing apparatus as a client computer receives a plurality of kinds of reproduction data from a server computer, and reproduces each of the plurality of kinds of reproduction data received by the receiving device. The data synchronizing apparatus acquires synchronization information for synchronizing the plurality of kinds of reproduction data to be individually reproduced, from the server computer, and synchronizes the plurality of kinds of reproduction data being individually reproduced, based on the acquired synchronization information.

### BACKGROUND OF THE INVENTION

1. Field of the Invention

The present invention relates to a data synchronizing apparatus and a data synchronizing method which synchronizes a plurality of kinds of data that are received, and reproduce the synchronized data, a program for implementing the data synchronizing method, a synchronization information transmitting apparatus and a synchronization information transmitting method which transmit synchronization information to the data synchronizing apparatus, etc., and a program for implementing the synchronization information transmitting method.

2. Description of the Related Art

A reproducing apparatus has hitherto been known which receives a plurality of kinds of reproduction data, such as MIDI (Musical Instrument Digital Interface) data, image data and audio data, from a server computer via, for example, a communication network, and which reproduces the received plurality of kinds of reproduction data. In the present specification, the term “reproduction” is defined to denote not reproduction after all data to be reproduced have been downloaded, but reproduction while downloading part of the data, namely, so-called streaming reproduction.

In reproducing different kinds of reproduction data individually and simultaneously, because the method of reproducing reproduction data, the data capacity, etc. depend on the kind of data and hence a timing deviation would occur between, for example, the reproduced image and the reproduced speech if these different kinds of data are reproduced individually, and thus synchronized reproduction cannot be achieved. To avoid this inconvenience, in the conventional reproducing apparatus, when transmitting data to the reproducing apparatus, the server computer generates these kinds of data with the respective reproduction timing shifted between the kinds of data in view of the above reproduction timing deviation before transmitting the kinds of data, and the reproducing apparatus reproduces the received data as they are without doing anything to synchronize the data.

However, in the above conventional reproducing apparatus, the extent of the reproduction timing deviation occurring between the kinds of data varies with conditions (e.g., processing capacity and communication environment) of the reproducing apparatus that receives the data. Therefore, even if the reproduction timing for one or more of the kinds of data is adjusted as accurately as possible on the server computer side, such reproduction timing deviation inevitably occurs to a more or less extent on the reproducing apparatus side.

### SUMMARY OF THE INVENTION

It is a first object of the present invention to provide a data synchronizing apparatus and a data synchronizing method which enable reproduction of a plurality of kinds of received data that are received in accurate synchronism, and also a program for implementing the data synchronizing method.

It is a second object of the present invention to provide a synchronization information transmitting apparatus and a synchronization information transmitting method which transmit synchronization information to the data synchronizing apparatus, etc., and also a program for implementing the synchronization information transmitting method.

To attain the first object, in a first aspect of the present invention, there is provided a data synchronizing apparatus comprising a receiving device that receives a plurality of kinds of reproduction data, a reproducing device that reproduces each of the plurality of kinds of reproduction data received by the receiving device, an acquisition device that acquires synchronization information for synchronizing the plurality of kinds of reproduction data to be individually reproduced, and a synchronizing device that executes synchronization of the plurality of kinds of reproduction data being individually reproduced, based on the synchronization information acquired by the acquisition device.

With the arrangement of the first aspect of the present invention, synchronization information for synchronizing a plurality of kinds of reproduction data is acquired and synchronization of the plurality of kinds of reproduction data is carried out based on the acquired synchronization information. Since synchronization of the plurality of kinds of received reproduction data is thus carried out at the receiving end, it is possible to reproduce the plurality of kinds of received reproduction data in accurate synchronism.

Preferably, the synchronization information comprises a plurality of prospective start-setup time periods that are assumed when reproduction of respective ones of the plurality of kinds of reproduction data is started by the reproducing device, and a plurality of initial delay time periods corresponding to respective ones of the plural prospective start-setup time periods, and wherein the initial delay time periods are each set at such a value that a sum of a corresponding one of the prospective start-setup time periods and the initial delay time period is equal between the plurality of kinds of reproduction data.

More preferably, the synchronizing device is responsive to occurrence of an deviation in reproduction timing between the plurality of kinds of reproduction data when reproduction of the plurality of kinds of reproduction data is started, for synchronizing the plurality of kinds of reproduction data being reproduced by prolonging or shortening each of the initial delay time periods according to an extent of the deviation.

To attain the first object, the first aspect of the present invention also provides a data synchronizing method comprising a receiving step of receiving a plurality of kinds of reproduction data, a reproducing step of reproducing each of the plurality of kinds of reproduction data received in the receiving step, an acquisition step of acquiring synchronization information for synchronizing the plurality of kinds of reproduction data to be individually reproduced, and a synchronizing step of synchronizing the plurality of kinds of reproduction data being individually reproduced, based on the synchronization information acquired in the acquisition step.

To attain the first object, the first aspect of the present invention further provides a program for causing a computer to execute the above data synchronizing method.

To attain the second object, in a second aspect of the present invention, there is provided a synchronization information transmitting apparatus comprising a transmitting device that transmits synchronization information for synchronizing a plurality of kinds of reproduction data being individually reproduced, to a reproducing apparatus that receives the plurality of kinds of reproduction data and individually reproduces the received plurality of kinds of reproduction data.

With the arrangement according to the second aspect of the present invention, synchronization information for synchronizing a plurality of kinds of reproduction data is transmitted to a reproducing apparatus that receives and reproduces the different kinds of reproduction data individually. Since synchronization of the plurality of kinds of reproduction data is assigned to the reproducing apparatus, the process of transmitting the plurality of kinds of reproduction data can be simplified to thereby lower the cost.

The above and other objects, features, and advantages of the invention will become more apparent from the following detailed description taken in conjunction with the accompanying drawings.

### BRIEF DESCRIPTION OF THE DRAWINGS

FIG. 1 is a block diagram showing the schematic configuration of a data synchronizing apparatus according to an embodiment of the present invention;

FIG. 2 is a view showing an example of the configuration of a server-client system including the data synchronizing apparatus of FIG. 1;

FIGS. 3A-3B are diagrams showing an example of formats of a plurality of kinds of data which are transmitted from a server computer transmits to a client computer, in which:

FIG. 3A shows a format of reproduction object data; and

FIG. 3B shows a format of reproduction special data;

FIGS. 4A-4B are diagrams showing a manner in which synchronization is executed by the data synchronizing apparatus of FIG. 1, in which:

FIG. 4A shows a manner in which different kinds of data are reproduced during synchronization; and

FIG. 4B shows a manner in which the different kinds of data are reproduced after synchronization;

FIG. 5 is a view useful in explaining a data synchronizing method carried out by the data synchronizing apparatus of FIG. 1; and

FIGS. 6A-6B is a flowchart showing the procedure of a main routine executed by the data synchronizing apparatus, particularly a CPU (Central Processing Unit), of FIG. 1.

### DETAILED DESCRIPTION OF THE PREFERRED EMBODIMENTS

The present invention will now be described in detail with reference to the drawings showing a preferred embodiment thereof.

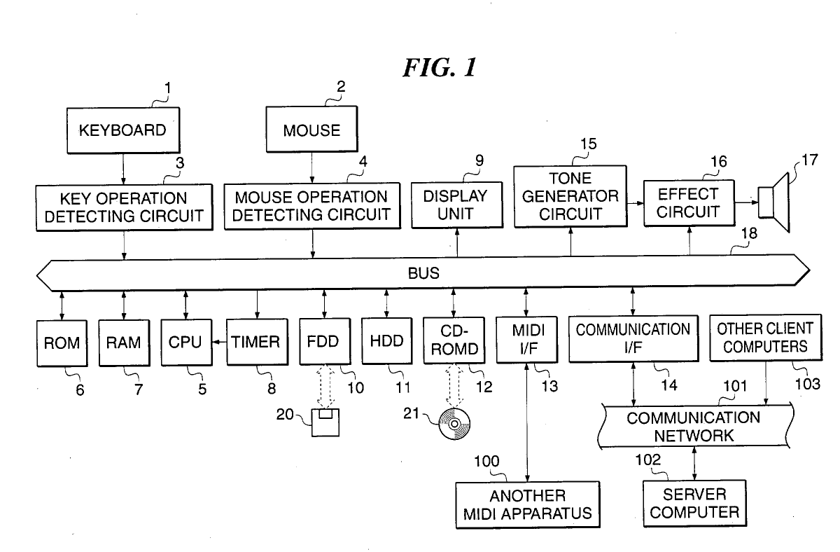

FIG. 1 is a block diagram showing the schematic configuration of a data synchronizing apparatus according to an embodiment of the present invention.

As shown in the figure, the data synchronizing apparatus according to the present embodiment is comprised of a keyboard 1 for inputting mainly character information, a mouse 2 serving as a pointing device, a key operation detecting circuit 3 for detecting operation states of individual keys of the keyboard 1, a CPU (Central Processing Unit) 5 which controls the entire apparatus, a ROM (Read Only Memory) 6 that stores control programs to be executed by the CPU 5; various table data, etc., a RAM (Random Access Memory) 7 for temporarily storing performance data, various kinds of input information, arithmetic operation results, etc., a timer 8 for measuring an interrupt time and various kinds of times used in execution of a timer interrupt process, a display unit 9 equipped with, for example, a large-size liquid crystal display (LCD), a CRT (Cathode Ray Tube) display or light emitting diodes (LEDs), for displaying various kinds of information, etc., a flexible disk drive (FDD) 10 for driving a flexible disk (FD) 20 being a storage medium, a hard disk drive (HDD) 11 for driving a hard disk (not shown) which stores various application programs including the above-mentioned control program, various kinds of data, etc., a CD-ROM drive (CD-ROMD) 12 for driving a compact disk read-only memory (CD-ROM) 21 which stores various application programs including the above-mentioned programs, various kinds of data, etc., a MIDI interface (I/F) 13 for inputting MIDI data from external apparatuses and outputting MIDI data to external apparatuses; a communication interface (I/F) 14 for performing transfer of data to and from, for example, a server computer 102 via a communication network 101, a tone generator circuit 15 for converting performance data input via the MIDI I/F 13 or the communication I/F 14, preset performance data, etc. into musical tone signals, an effect circuit 16 for applying various types of effects to musical tone signals from the tone generator circuit 15, and a sound system 17, such as a DAC (Digital-to-Analog Converter), an amplifier, and a speaker, for converting the resulting musical tone signals from the effect circuit 16, into sounds.

These components 3 through 16 are interconnected via a bus 18, the timer 8 is connected to the CPU 5, another MIDI apparatus 100 is connected to the MIDI I/F 13, the communication network 101 is connected to the communication I/F 14, the effect circuit 16 is connected to the tone generator circuit 15, and the sound system 17 is connected to the effect circuit 16.

In the hard disk of the HDD 11, as stated above, also control programs to be executed by the CPU 5 can be stored. When a control program is stored in advance in the hard disk even if the control program is not stored in the ROM 6, the CPU 5 reads the control program from the hard disk into the RAM 7 to perform the same operation as if the control program is actually stored in the ROM 6. This facilitates, for example, installation of an additional control program or version up of an existing control program.

The control programs and various kinds of data read from the CD-ROM 21 of the CD-ROM drive 12, are stored in the hard disk of the HDD 11, thereby facilitating installation of a new control program or version up of an existing control program. It should be noted that in addition to the CD-ROM drive 12, a magneto-optical (MO) disk drive or any other device adapted to use various types of media may be provided as an external storage device.

As stated above, the communication I/F 14 is connected to the communication network 101 such as a LAN (Local Area Network), the Internet, or a telephone line, so that it can be connected to the server computer 102 via the communication network 101. When one or more of the above-mentioned various programs and various parameters are not stored in the hard disk in the HDD 11, the communication I/F 14 is used to download such program(s) and parameters from the server computer 10. A client computer (the data synchronizing apparatus in the present embodiment) transmits a command requesting to download program(s) and/or parameters to the server computer 102 via the communication I/F 14 and the communication network 101. Responsive to this command, the server computer 102 delivers (transmits) the requested program(s) and/or parameters to the client computer via the communication network 101, whereupon the client computer stores the received program(s) and/or parameters in the hard disk of the HDD 11, thereby completing the downloading.

In addition, the data synchronizing apparatus may be equipped with an interface for performing direct exchange of data with an external computer, etc.

As is understood from the above-described construction, the data synchronizing apparatus according to the present embodiment is constructed on a general-purpose type personal computer. However, the data synchronizing apparatus should by no means be limited to this illustrated example, and may be constructed on a dedicated apparatus that is comprised of only a minimum required number of components essential to implement the present invention.

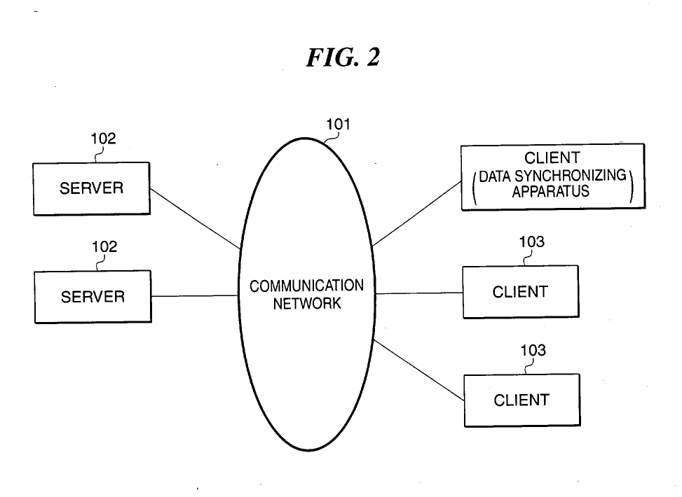

As shown in FIG. 2, the data synchronizing apparatus according to the present embodiment is configured as a single client computer of a server-client system that is comprised of a plurality of server computers 102 and a plurality of client computers 103, which are connected to each other via the communication network 101.

The server computer 102 transmits a plurality of kinds of reproduction data; i.e., performance data, audio data and image data, to the plurality of client computers including the data synchronizing apparatus of the present embodiment.

When any of the plurality of client computers, e.g., the data synchronizing apparatus of the present embodiment makes a request to either one of the two server computers 102 for delivery of reproduction data, the one of the server computers 102 delivers a plurality of kinds of reproduction data to the data synchronizing apparatus of the present embodiment in response to the request.

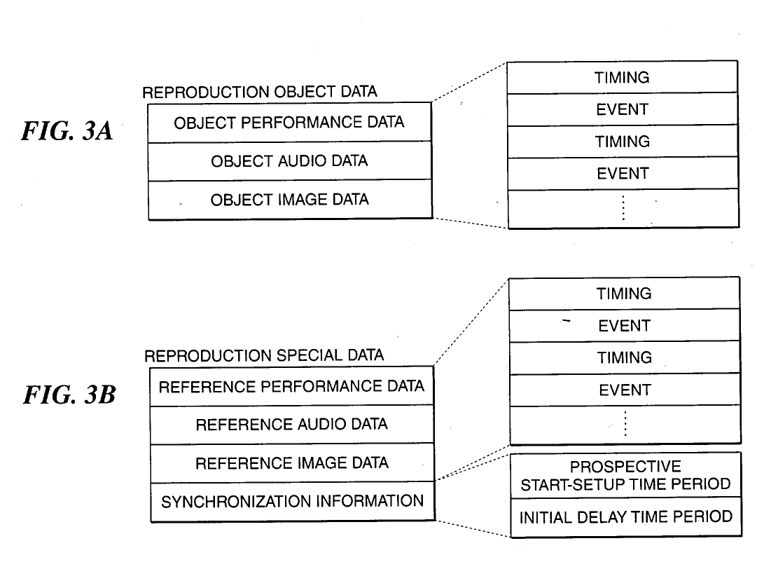

FIGS. 3A and 3B are diagrams showing an example of formats of a plurality of kinds of reproduction data transmitted from each of the server computers to a client computer, in which FIG. 3A shows a format of reproduction object data, and FIG. 3B shows a format of reproduction special data.

The reproduction object data is reproduction data proper that the user wishes to reproduce and, as shown in FIG. 3A, is comprised of three kinds of object data; i.e., object performance data, object audio data, and object image data. These three kinds of object data are transmitted from each server computer to a client computer in the form of a file at a time, the file containing an amount of the three kinds of object data that corresponds to reproduction for a predetermined unit time (e.g., one minute).

Each of the three kinds of data composing the reproduction object data is composed of a sequence of event data and timing data (the timing represents a time point an immediately following event is to be reproduced). The three kinds of data are identical in format and different only in kind of event data. Namely, events of the object performance data are performance events (e.g., MIDI events) for synthesizing musical tone signals, events of the object audio data are events of sampling data (e.g., PCM (Pulse Code Modulation) data) for reproducing speech, and events of the object image data are events of image display data (e.g., bit map data) for displaying dynamic images.

On the other hand, the reproduction special data is data serving to synchronize the different kinds of object data composing the reproduction object data and, as shown in FIG. 3B, is comprised largely of three kinds of data; i.e., reference performance data, reference audio data, and reference image data. These three kinds of data are transmitted from each server computer to a client computer in the form of a file at a time, the file containing an amount of the three kinds of reference data that corresponds to reproduction for a predetermined unit time (e.g., one minute).

Like the reproduction object data, each of the three kinds reference data composing the reproduction special data is composed of a sequence of event data and timing data. The three kinds of data are identical in format and different only in kind of event data. Namely, events of each of the reference performance data, reference audio data, and reference image data are of the same nature as events of the data of the kinds composing the reproduction object data; i.e., the events of the object performance data, events of the object audio data, and events of the object image display data. However, events of the reference performance data are performance events for synthesizing click tones as musical tone signals., events of the reference audio data are events of sampling data for reproducing the click tones, and events of the reference image data are events of image display data for displaying dynamic image indicating proper synchronizing timing, e.g., dynamic image of a metronome. As described later, the three kinds of reference data are reproduced individually so that the extent of reproduction timing deviation occurring between these different kinds of reference data can be determined, and therefore the user can adjust the reproduction timing of each kind of reference data so as to eliminate the reproduction timing deviation, that is, establish synchronization of reproduction between the three kinds of data of the reproduction object data.

Further, the reproduction special data additionally includes synchronization information. If only the three kinds of reference data were faithfully reproduced, the degree of reproduction timing deviation between the different kinds of reference data would be usually too large to adjust or eliminate. Therefore, it is desirable to make a pre-adjustment in order to minimize the extent of a possible reproduction timing deviation. The synchronization information is used for this pre-adjustment. As shown in FIG. 3B, the synchronization information is comprised of prospective start-setup time data and initial delay time data. The prospective start-setup time data is provided for each of the three kinds of reference data composing the reproduction special data; i.e., the prospective start-setup time data has recorded therein an estimated value of the setup time period before the start of sounding for each kind of reference data. Likewise, the initial delay time data also is provided for each of the three kinds of reference data composing the reproduction special data, and the initial delay time data has recorded therein an initial delay time period for each kind of reference data, which is essential to synchronize the sounding start timing of each kind of reference data. Each of the initial delay time period is set such that the sum of the value of a corresponding one of the prospective start-setup time period and the value of the initial delay time period is equal between all the kinds of reference data.

As described later, when the user makes a request to the server computer 102 for delivery of information that he or she wishes to reproduce, the server computer 102 responds to the request and delivers to the user's data synchronizing apparatus reproduction object data to be reproduced first and corresponding reproduction special data (for synchronization) peculiar to the reproduction object data. To this end, the correlation is provided between reproduction object data and reproduction special data to be delivered together therewith.

Although in the present embodiment, all the three kinds of object data composing the reproduction object data and all the three kinds of reference data composing the reproduction special data are identical in data format, alternatively, data in different formats may be employed as these kinds of data. For example, audio data and image data may be in a format that is comprised of only event data and does not include timing data.

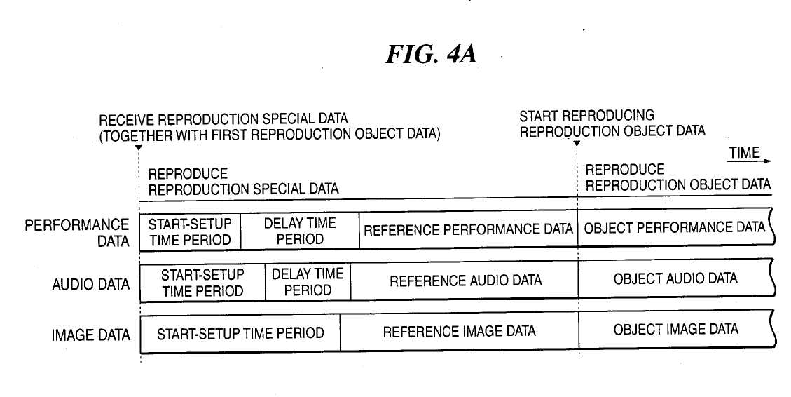

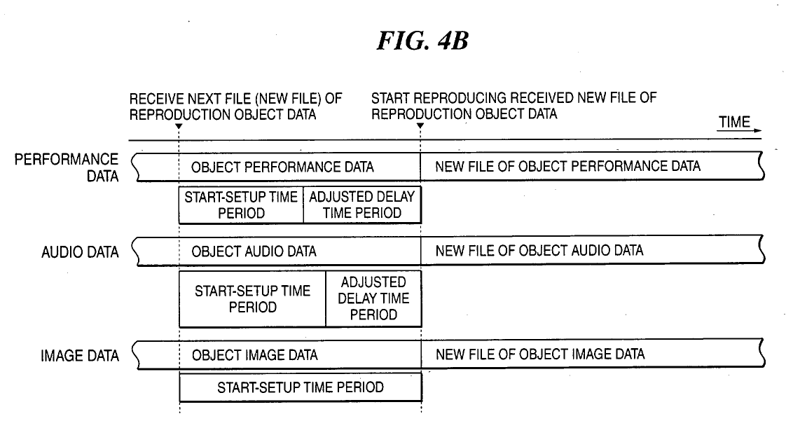

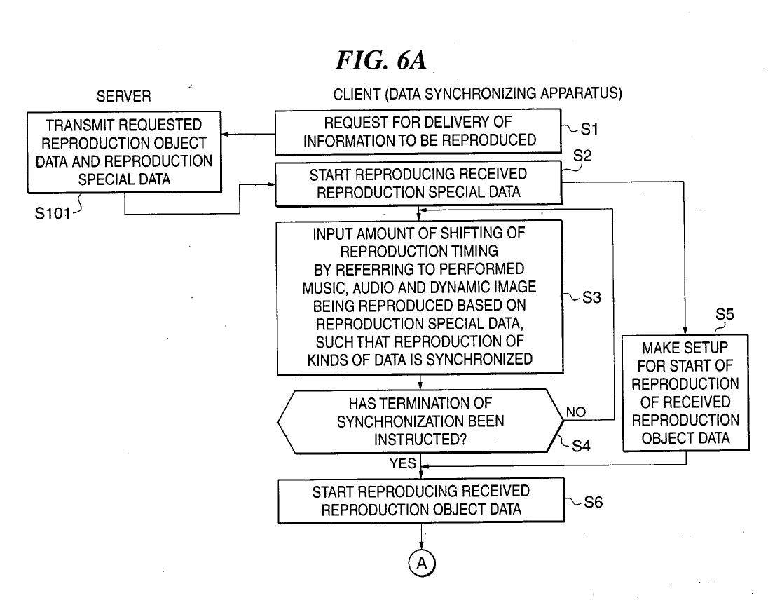

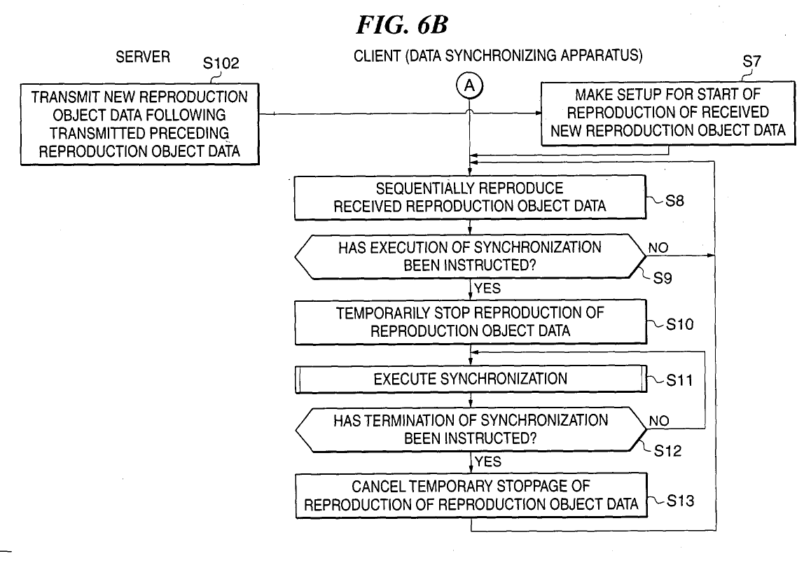

Next, a description will be given of a control process performed by the data synchronizing apparatus according to the present embodiment constructed as above. First, the outlines of the control process will be described with reference to FIGS. 4A-4B, and then the details of the same will be described with reference to FIGS. 6A-6B.

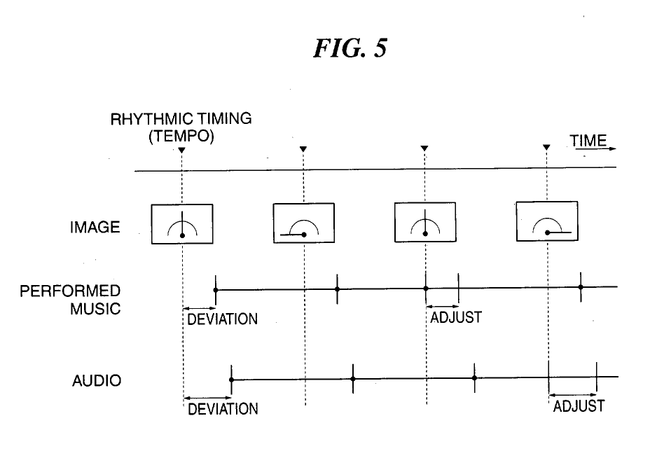

FIGS. 4A-4B are diagrams showing the manner of synchronization performed by the data synchronizing apparatus of the present embodiment, in which FIG. 4A shows the manner in which various kinds of data are reproduced during the synchronization, and FIG. 4B shows the manner in which the various kinds of data are reproduced after the synchronization. FIG. 5 is a view useful in explaining how the synchronization is carried out.

When the data synchronizing apparatus according to the present embodiment accesses to the server computer 102 and makes a request for delivery of information to be reproduced by the data synchronizing apparatus, the server computer 102 delivers to the data synchronizing apparatus reproduction object data to be reproduced first, and reproduction special data associated therewith. Upon receipt of the reproduction special data and reproduction object data, the data synchronizing apparatus of the present embodiment delays the reference performance data and reference audio data contained in the received reproduction special data based on the initial delay time period of the synchronization information contained in the received reproduction special data, and then starts reproducing the reference performance data and reference audio data, as shown in FIG. 4A.

Since among the three kinds of data, the image data requires a longest setup time to start its reproduction, the initial delay time period is set for each of the other kinds of data, i.e., performance data and audio data. Reproduction of each of the performance data and audio data is started after the lapse of the corresponding initial delay time period from completion of setup for the start of the reproduction. Meanwhile, reproduction of the image data is started immediately after completion of start-setup for the reproduction. Each start-setup time in FIGS. 4A-4B represents a time period which the start-setup actually took for start of the corresponding data in the data synchronizing apparatus of the present embodiment. Each delay time in FIG. 4A represents a time period corresponding to the corresponding initial delay time data read from the synchronization information. In FIG. 4A, the prospective start-setup time period of each kind of data is different from the actual start-setup time taken by the data synchronizing apparatus of the present embodiment, and therefore the three kinds of data are not completely synchronized in start timing for reproduction of the data.

Each of the three kinds of reference data, i.e., reference performance data, reference audio data and reference image data, composing the reference special data is delayed by a predetermined delay time period and, thereafter, reproduction of the three kinds of reference data is started in sequence. When reproduction of the three kinds of reference data is started, a dynamic image of, for example, a metronome whose pointer moves at intervals in terms of beats, as shown in FIG. 5, is reproduced based on the reference image data. Specifically, a sequence of click tones occurring at intervals in terms of beats, for example, are reproduced based on the reference performance data; a sequence of click tones occurring at intervals in terms of beats, for example, are reproduced based on the reference audio data. The user adjusts the timing of click tones according to the reference performance data to the movement of the pointer of the metronome by operating a predetermined key of the keyboard 1, namely, synchronizes the timing of reproduction of the reference performance data with the timing of reproduction of the reference image data, and then the delay time of FIG. 4A is prolonged or shortened in response to this adjustment, and is thereby changed to the adjusted delay time of FIG. 4B. The reference audio data as well has its timing of reproduction synchronized with the timing of reproduction of the reference image data in the same manner as that of the reference performance data. After synchronization of both the reference performance data and the reference audio data with the reference image data is completed, reproduction of the reproduction object data is started upon receipt of an instruction from the user. On this occasion, as shown in FIG. 4A, the three kinds of data have been already synchronized, the object performance data, object audio data and object image data composing the reproduction object data start to be reproduced in the same timing.

While the reproduction object data is being reproduced, reproduction object data to be reproduced next is received, and start-setup of reproduction of the received reproduction object data is carried out for each kind of object data starting at a time point earlier by the start-setup time of the object image data. On this occasion, reproduction of the object image data is started immediately after the lapse of the start-setup time. Meanwhile, reproduction of each of the object performance data and the object audio data is started after the lapse of the changed delay time for each of the object performance data and the object audio data from the lapse of the reproduction start-setup time. In this way, also the three kinds of data of the reproduction object data to be reproduced next are reproduced in the same timing.

Next, the above-described control process will be described in detail.

FIGS. 6A-6B is a flowchart showing the procedure of a main routine executed by the data synchronizing apparatus, particularly the CPU 5, of the present embodiment. It should be noted that, as described above, the data synchronizing apparatus of the present embodiment is a client computer of a server-client system and makes exchange of data with the server computer, and therefore, a control process executed by the server computer is also described in part in the flowchart of FIGS. 6A-6B. Further, although in addition to the illustrated processes, other processes such as an initializing process are included in the main routine, illustration and description of the other processes are omitted because they are not essential in explaining the features of the present invention.

In FIGS. 6A-6B, first the data synchronizing apparatus of the present embodiment makes a request to the server computer 102 for delivery of information to be reproduced (step S1), and then the server computer 102 transmits reproduction object data and reproduction special data associated therewith, in response to the request (step S101).

Upon receipt of the reproduction object data and the reproduction special data from the server computer 102, the data synchronizing apparatus first starts reproduction of each kind of reference data contained in the reproduction special data (step S2). Specifically, as described above by referring to FIG. 4A, the reference performance data, reference audio data and reference image data composing the reproduction special data are delayed based on synchronization information contained in the reproduction special data, and then reproduction of these three kinds of reference data is started.

Then, when the user inputs an amount of timing shifting so as to obtain synchronized reproduction of the different kinds of data while referring to performance, audio sound and dynamic image being reproduced based on the respective kinds of reference data, the delay time of initial delay time data (corresponding to the performance data and audio data) composing the synchronization information is changed in accordance with the input amount of timing shifting, and the resulting delay time is stored as the changed delay time in FIG. 4B.

When reproduction of all the kinds of reference data is synchronized, the user gives to the client computer an instruction to terminate the synchronization. In response to the user's instruction, the client computer starts reproducing the reproduction object data received in step S2 (step S4-step S6). It should be noted that, before the reproduction of reproduction object data is started in the step S6, the setup for start of reproduction of the received reproduction object data is carried out in the step S5.

When reproduction of the reproduction object data is started in the step S6, musical tones based on the performance data of the reproduction object data are reproduced using the tone generator circuit 15, the effect circuit 16 and the sound system 17; audio signals, such as speech and musical tones, based on audio data are reproduced using the sound system 17; and images based on the image data are sequentially displayed on the display unit 9 (step S8). During this reproduction, the next reproduction object data following the transmitted preceding reproduction object data is delivered from the server computer 102 to the client computer (step S102), and upon receipt of the next reproduction object data, the client computer makes setup for start of reproduction of the received next data (step S7). Then, as described above, in the step S8, the object image data is reproduced immediately after the lapse of the start-setup time, and the object performance data and object audio data are reproduced after the lapse of the changed delay time from the lapse of the start-setup time.

At the time point the process proceeds to the reproduction process of the step S8, the timing for start of reproduction of all the three kinds of object data composing the reproduction object data has already been accurately synchronized and therefore, each of these three kinds of object data is reproduced smoothly without giving an unnatural feeling.

In subsequent steps S9-S13, a readjustment is carried out if the timing for reproduction of the reproduction object data comes out of synchronism for some cause.

First, when the user gives an instruction to carry out synchronization, reproduction of the reproduction object data is temporarily stopped (step 9-step 10), and a data synchronizing subroutine is carried out (step S11). Specifically, this data synchronizing subroutine is comprised of the same procedure as in steps S2 and S3, and therefore description thereof is omitted.

Thereafter, when reproduction of all the three kinds of reference data becomes synchronized, and the user gives an instruction to terminate the synchronization, the temporary stoppage of reproduction of the reproduction object data is canceled in response to the user's instruction (step S12-step S13), and then the process returns to the step S8 to sequentially reproduce the received reproduction object data.

In the above-described manner, according to the present embodiment, when the data synchronizing apparatus requests the server computer to deliver reproduction object data, the server computer delivers to the data synchronizing apparatus the requested reproduction object data together with the reproduction special data which can be used for synchronization by the data synchronizing apparatus. Then, the data synchronizing apparatus can by itself perform synchronization of the reproduction object data based on the received reproduction special data, and therefore, the received plurality of kinds of object data can be reproduced in accurate synchronism.

Further, the server computer is freed from taking account of synchronization of reproduction object data executed by the client computer, and therefore the delivering process of reproduction object data can be simplified, thereby enabling reduction of the running cost on the server computer 102 side.

Although in the present embodiment, the server computer delivers to the data synchronizing apparatus the reproduction object data with reproduction special data added thereto, the object of the present invention can be alternatively achieved so long as proper synchronization of the reproduction object data can be made based on the reproduction object data received from the server computer. Therefore, the server computer may not need add the reproduction special data to the reproduction object data when delivering the reproduction object data. For example, information which can be used for synchronization may be embedded in the reproduction object data, or the reproduction object data may be in a special format so that synchronization is carried out based on the reproduction object data per se.

Furthermore, although in the present embodiment, as shown in FIGS. 3A-3B, both the reproduction object data and the reproduction special data are transmitted in units of files at a time, each file containing three kinds of object data or three kinds of reference data alternatively, the three kinds of data, i.e. object data and reference data, may be transmitted in respective different separate files. In this case, each of the respective files of a plurality of kinds of object data may contain corresponding one of as many kinds of reference data of the reproduction special data (specifically, corresponding one of the three kinds of reference data and corresponding synchronization information). The server computer transmits to the data synchronizing apparatus (client computer) of the present embodiment the present files each composed of one of the plurality of kinds of object data, corresponding one of the kinds of reference data and corresponding synchronization information. The data synchronizing apparatus starts reproduction of reference data corresponding to respective object data in the files in the order in which the files are received. When all the kinds of reference data have been reproduced, the data synchronizing apparatus permits the user to perform synchronization. With the reproduction object data and reproduction special data being thus configured, a difference in transmitting time between the different kinds of data becomes noticeable during synchronization as a reproduction timing deviation. Consequently, the value of initial delay time data in the synchronization information contained in each kind of reproduction special data is determined by taking into account the transmitting time which depends upon individual kinds of data, and the determined value is stored.

Further, in the case where the server computer thus transmits a plurality of kinds of data separately, it may be arranged such that the client computer obtains necessary information from as many server computers as the number of the plurality of kinds of data.

Still further, although in the present embodiment, the number of kinds of data to be transmitted from the server computer is three, it goes without saying that the present invention should not be limited to this example. For example, the server computer may prepare a required number of kinds of reproduction special data in accordance with the kinds of reproduction object data and transmits the required number of kinds of data to the data synchronizing apparatus (client computer) of the present embodiment.

Furthermore, although in the present embodiment, as described with reference to FIG. 5, synchronization is carried out by the user operating a predetermined operating element (a predetermined key of the keyboard 1) while watching a dynamic image of a metronome and at the same time, listening to click tones generated based on the reference performance data and the reference audio data, the present invention is not limited to this synchronizing method, and any other method may be employed insofar as the timing of reproduction of plurality of kinds of data can be synchronized, namely, the delay time can be adjusted. For example, a synchronizing method which employs a timing adjusting manner similar to that of an GUI (Graphical User Interface), that is, the user drags and drops a cursor, not shown, on an image as shown in FIG. 5 displayed on the display unit 9, to point a position where a reproduction timing deviation appears, so as to eliminate the reproduction timing deviation.

It is to be understood that the object of the present invention may also be accomplished by supplying a system or an apparatus with a storage medium in which a program code of software which realizes the functions of the above described embodiment is stored, and causing a computer (or CPU or MPU) of the system or apparatus to read out and execute the program code stored in the storage medium.

In this case, the program code itself read from the storage medium realizes the functions of the embodiments described above, and hence the storage medium on which the program code is stored constitutes the present invention.

Examples of the storage medium for supplying the program code include a floppy (registered trademark) disk, a hard disk, an optical disk, a magnetic-optical disk, a CD-ROM, a CD-R, a CD-RW, DVD-ROM, a DVD-RAM, a DVD-RW, a DVD+RW, a magnetic tape, a nonvolatile memory card, and a ROM. As an alternative, the program code may be supplied from the server computer 102 via the other MIDI apparatus 100 and the communication network 101.

Further, it is to be understood that the functions of the above described embodiment may be accomplished not only by executing a program code read out by a computer, but also by causing an OS (operating system) or the like which operates on the computer to perform a part or all of the actual operations based on instructions of the program code. Further, it is to be understood that the functions of the above described embodiment may be accomplished by writing a program code read out from the storage medium into an expansion board inserted into a computer or a memory provided in an expansion unit connected to the computer and then causing a CPU or the like provided in the expansion board or the expansion unit to perform a part or all of the actual operations based on instructions of the program code.

What is claimed is:

1. A data synchronizing apparatus comprising:
a receiving device that receives a plurality of kinds of reproduction data;
a reproducing device that reproduces each of the plurality of kinds of reproduction data received by said receiving device;
an acquisition device that acquires synchronization information for synchronizing the plurality of kinds of reproduction data to be individually reproduced; and
a synchronizing device that executes synchronization of the plurality of kinds of reproduction data being individually reproduced, based on the synchronization information acquired by said acquisition device.

2. A data synchronizing apparatus according to claim 1, wherein the synchronization information comprises a plurality of prospective start-setup time periods that are assumed when reproduction of respective ones of the plurality of kinds of reproduction data is started by said reproducing device, and a plurality of initial delay time periods corresponding to respective ones of the plural prospective start-setup time periods, and wherein the initial delay time periods are each set at such a value that a sum of a corresponding one of the prospective start-setup time periods and the initial delay time period is equal between the plurality of kinds of reproduction data.

3. A data synchronizing apparatus according to claim 2, wherein said synchronizing device is responsive to occurrence of an deviation in reproduction timing between the plurality of kinds of reproduction data when reproduction of the plurality of kinds of reproduction data is started, for synchronizing the plurality of kinds of reproduction data being reproduced by prolonging or shortening each of the initial delay time periods according to an extent of the deviation.

4. A data synchronizing method comprising:
a receiving step of receiving a plurality of kinds of reproduction data;
a reproducing step of reproducing each of the plurality of kinds of reproduction data received in said receiving step;
an acquisition step of acquiring synchronization information for synchronizing the plurality of kinds of reproduction data to be individually reproduced; and
a synchronizing step of synchronizing the plurality of kinds of reproduction data being individually reproduced, based on the synchronization information acquired in said acquisition step.

5. A program for causing a computer to execute a data synchronizing method comprising:
a receiving step of receiving a plurality of kinds of reproduction data;
a reproducing step of reproducing each of the plurality of kinds of reproduction data received in said receiving step;
an acquisition step of acquiring synchronization information for synchronizing the plurality of kinds of reproduction data to be individually reproduced; and
a synchronizing step of synchronizing the plurality of kinds of reproduction data being individually reproduced, based on the synchronization information acquired in said acquisition step.

6. A synchronization information transmitting apparatus comprising:
a transmitting device that transmits synchronization information for synchronizing a plurality of kinds of reproduction data being individually reproduced, to a reproducing apparatus that receives the plurality of kinds of reproduction data and individually reproduces the received plurality of kinds of reproduction data.

7. A synchronization information transmitting method comprising:
a transmitting step of transmitting synchronization information for synchronizing a plurality of kinds of reproduction data being individually reproduced, to a reproducing apparatus that receives the plurality of kinds of reproduction data and individually reproduces the received plurality of kinds of reproduction data.

8. A program for causing a computer to execute a synchronization information transmitting method comprising:
a transmitting step of transmitting synchronization information for synchronizing a plurality of kinds of reproduction data being individually reproduced, to a reproducing apparatus that receives the plurality of kinds of reproduction data and individually reproduces the received plurality of kinds of reproduction data.

9. A server-client system comprising:
at least one data synchronizing apparatus as a client; and
at least one synchronization information transmitting apparatus as a server;
said data synchronizing apparatus comprising:
a receiving device that receives a plurality of kinds of reproduction data;
a reproducing device that reproduces each of the plurality of kinds of reproduction data received by said receiving device;
an acquisition device that acquires synchronization information for synchronizing the plurality of kinds of reproduction data to be individually reproduced; and
a synchronizing device that executes synchronization of the plurality of kinds of reproduction data being individually reproduced, based on the synchronization information acquired by said acquisition device;
said synchronization information transmitting apparatus comprising:
a transmitting device that transmits the synchronization information to said data synchronizing apparatus.

10. A server-client system according to claim 9, wherein said transmitting device of said synchronization information transmitting apparatus further transmits the plurality of kinds of reproduction data to said data synchronizing apparatus.
